(19) United States
(12) Patent Application Publication
(10) Pub. No.: US 2016/0008208 A1
(43) Pub. Date: Jan. 14, 2016

(54) SOFT TISSUE ACTIVE RELEASE SYSTEM

(71) Applicant: Tait Yoder, Albuquerque, NM (US)

(72) Inventor: Tait Yoder, Albuquerque, NM (US)

(21) Appl. No.: 13/863,365

(22) Filed: Apr. 15, 2013

Related U.S. Application Data
(60) Provisional application No. 61/624,383, filed on Apr. 15, 2012.

(51) Int. Cl. A61H 7/00; A61H 1/00

(52) U.S. Cl. CPC A61H 7/001; A61H 1/008; A61H 2201/1697; A61H 2205/06; A61H 2205/065; A61H 2205/12; A61H 2205/10; A61H 2205/08

(57) ABSTRACT

Soft tissue active release systems are described. The systems can include different shaped injection pressure modules which attach to a neoprene wrap via a strap having a fastening system such as hook and loop.

### CROSS REFERENCE TO RELATED APPLICATIONS

This application claims the benefit of U.S. Provisional Application No. 61/624,383, entitled “Soft Tissue Active Release System” and filed on Apr. 15, 2012, which is incorporated herein by reference in its entirety.

### FIELD

Embodiments relate generally to therapeutic devices, and, more particularly to therapeutic devices for soft tissue active release.

### BACKGROUND

Treatment of muscular tension, adhesions found within soft tissue fibers, inflammation and lack of range of motion plague our society and methods for alleviating and eliminating such systemic problems poses a significant cost to our health care industry. There may be a need in the sports medicine field to provide more than just compression of muscle tissue from the common neoprene wraps found on the market today.

### SUMMARY

Some implementations can help provide musculo-skeletal support and help minimize the size and effect of adhesions or lesions in soft tissue structures, such as muscles, tendons fascia, and nerves. Also, some implementations can include different sized neoprene wraps with hook and loop attachments. Each of the wraps can have a system to intensify compression with elastic straps sewn to the neoprene and attached via hook and loop.

The precision of applying direct stimulation to muscle fibers in conjunction with compression wraps provides a new level of customizability along with variable accurate compression capabilities that will help reduce recovery time, help reduce inflammation caused from muscular stress to tendons and ligaments, and provide spot specific penetration to muscular tissue. It can be helpful for a user to be directed on proper manual manipulation of their body including moving their symptom pattern area while the modular is held in place at the contact point under tension.

Some implementations can also include different shaped injection molded FDA approved modulars which attach to the neoprene wraps via hook and loop. This device allows the user to active the soft tissue structures where the wrap and modular have been placed. This system includes the steps of locating adhesions, trigger points, muscular dysfunctions, and pain throughout the entire body. Further steps involve how a medical professional or the user can apply the appropriate pressure by use of hook and loop attachment of the present system. Further instruction will address the use of the elastic compression straps attached by hook and loop or modifications of compression to provide additional focal compression to the neoprene wrap. The neoprene wrap design may have modifications of different materials which provide comfort, adjustability, elasticity, and simplicity of use.

Some implementations can include instruction for the various movement patterns including but not limited to flexion, extension, abduction, adduction, pronation, supination, elevation, depression, medial rotation, lateral rotation, retraction, protraction, side bending, upward rotation, downward rotation, and all combinations of each movement. These movement exercises can demonstrate how to use the present system to effectively treat soft tissue restrictions and adhesions, trigger points, muscular dysfunctions, and pain anywhere in the body. The instruction can demonstrate how to use the present system appropriately with each movement pattern for the many different soft tissue restrictions located throughout the body.

Some implementations can be beneficial treatment of carpal tunnel syndrome, tennis elbow, shin splints, sciatica, low back pain, and many other overuse injuries and aiding the musculo-skeletal system in the prevention of injury caused by strenuous exercise and/or athletic activities.

Some implementations can be used to provide constant frictionally resistive force, bidirectional in nature providing resistive force in multi-directions based on the user's movement patterns. Adjustment allows the user to set the level of modular penetration based on the user's desired outcomes. The device is adapted primarily for healthy muscle groups, but it may also be used for rehabilitative purposes. The present device provides adjustable fastening means to fit comfortably on different body types.

At least one embodiment of the present system provides muscular conditioning by utilizing adjustable compression with a 1 mm-3 mm neoprene wrap.

The wrap portion and the modular resistance elements with specifically designed shapes serve to cause the wearer of the device to provide active movements in various planes of motion exerting muscular contraction therefore causing a frictional response when the shaped modular contacts the user. The targeted muscle group is activated by the user thus engaging the active release mechanism as the modular is held in place by the neoprene wrap. Active release refers to holding a point of contact via the soft tissue active release modular system and activating muscular contraction and relaxation. The soft tissue active release wrap system is unique in its ability to serve as a platform for holding the soft tissue active release modulars in place anywhere on the body, comfortably, with little effort on the part of the user. The soft tissue active release wrap system permits adjustability with hook and loop straps.

The focal compression of the neoprene wrap with hook and look adjustability is further intensified with the use of 2″-4″dual elastic compression straps with hook and loop adjustability.

The material used for the wrap has a relatively high yield strength, is extremely fatigue resistant allowing for excellent adaptability to different areas of the body. The material of the soft tissue active release wrap is breathable, adaptable, stretchable, comfortable, and usable on any joint or area of the body around which it can be safely wrapped. This material also has an interior lining that allows the soft tissue active release modular to attach via hook and loop. This allows the soft tissue active release modulars to be interchangeable with any of the soft tissue active release wraps.

Some implementations of the present system can include muscle and joint appropriate wraps. Some implementations can target specific muscular locations.

Nerve innervation is also related to muscle spasm and trigger points. When a muscle is in a contracted state, it can compress the nerve signal to the brain. This deficit nerve signal can cause muscles to further harden and spasm. Since nerves travel through various muscle groups, the pain can be felt areas other than the originating site. Thus the need to chase the pain and follow muscular patterns via elicit pain symptoms is a relevant method for undoing pain cycles. Following trigger point patterns is an effective model for identifying pain in the body. Application of direct, sustained pressure onto identified trigger points can help to relieve muscular tension. Also beneficial is if the application of focal compression can be applied repeatedly, and at different angles. This pressure can interrupt the neural signal that causes both the spasm and the pain. The fascia can be treated via direct pressure, and as the muscle is activated under direct focal compression, a gliding stroke is created to further help dissolve restrictions.

Various embodiments of the present system will now be described more fully with reference to the accompanying drawings. The system may, however, be embodied in many different sizes and shapes employing the same system of soft tissue active release with modular attachments and thus should not be limited to the embodiments (or dimensions) set forth herein, rather, the embodiments and example dimensions are provided as example for purposes of illustration and explanation.

Some implementations of this system can induce cross-fiber, longitudinal sliding motions, for soft tissue in a human or animal body. The user can wear the device as necessary or appropriate as advised by the medical practitioner. Instructional videos will detail appropriate and safe use of an embodiment. Use should discontinue when the patients experiences undue discomfort or pain. It is expected that the user will experience some discomfort when using this device.

Some implementations can be used as a soft tissue focal compression system and may be utilized in areas of need such as, for example, a lower leg region, a arm region, a upper leg region, a hip region, a low back region, a upper back region, a shoulder region, a foot region, a ankle region, or the like of the user.

Some implementations can include shaped soft tissue active release modulars (or modules) made of injection molded rubber (e.g., having a hardness of 61 with +/−5 variability, shore A). Such materials and other similar materials been approved by the FDA for epithelial contact. The sizes of these modulars can vary between the current dimensions to increases or decreases anywhere from about ½″ to 6″. The circumferences of each modular may increase or decrease anywhere from about ½″ to 6″. The shapes of the soft tissue active release modulars may also vary and are not limited to the current drawings set forth. Possible future drawings include beveled, soft tissue active release shaped, cross shaped, and/or shaved dome of an increase or decrease in circumference of current shapes by about ½″ to 6″.

### BRIEF DESCRIPTION OF THE DRAWINGS

FIG. 1 is a diagram of an example small soft tissue active release extremity wrap used for application on the lower leg, arm regions, hand and foot in accordance with at least one embodiment.

FIGS. 2A-2C show an example wedge shaped injection molded FDA approved for epithelial contact soft tissue active release modular for specific point of contact along a greater width in accordance with at least one embodiment.

FIGS. 3A-3C show an example shaved dome shaped injection molded FDA approved for epithelial contact soft tissue active release modular for a more general point of contact in accordance with at least one embodiment.

FIGS. 4A-4C show tear drop shaped injection molded FDA approved for epithelial contact soft tissue active release modular for a singular, spot specific point of contact in accordance with at least one embodiment.

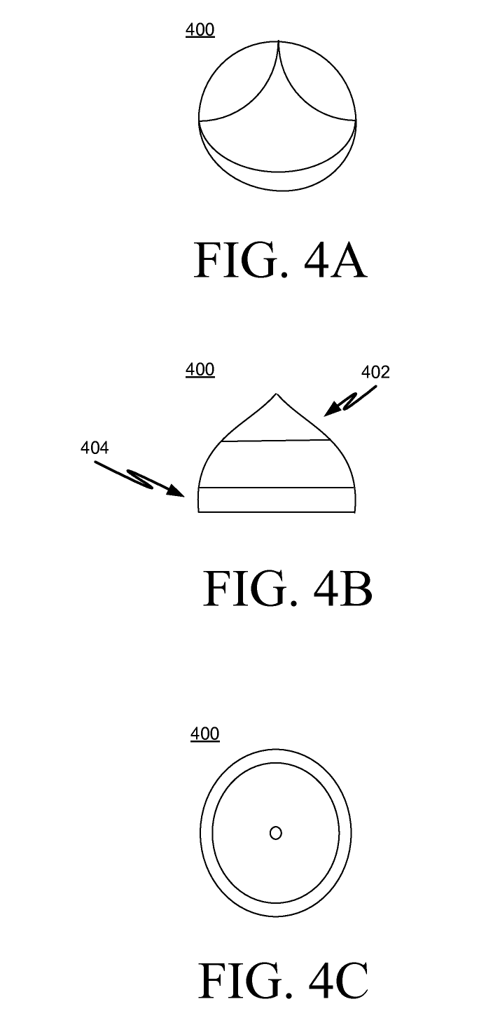

FIG. 5 shows an example pressure module having a generally star-shaped member in accordance with at least one embodiment.

FIG. 6 shows an example pressure module having a generally “S”-shaped member in accordance with at least one embodiment.

FIG. 7 shows an example pressure module having two intersecting generally “S”-shaped members in accordance with at least one embodiment.

FIG. 8 shows an example pressure module having a plurality of generally cylindrical members in accordance with at least one embodiment.

### DETAILED DESCRIPTION

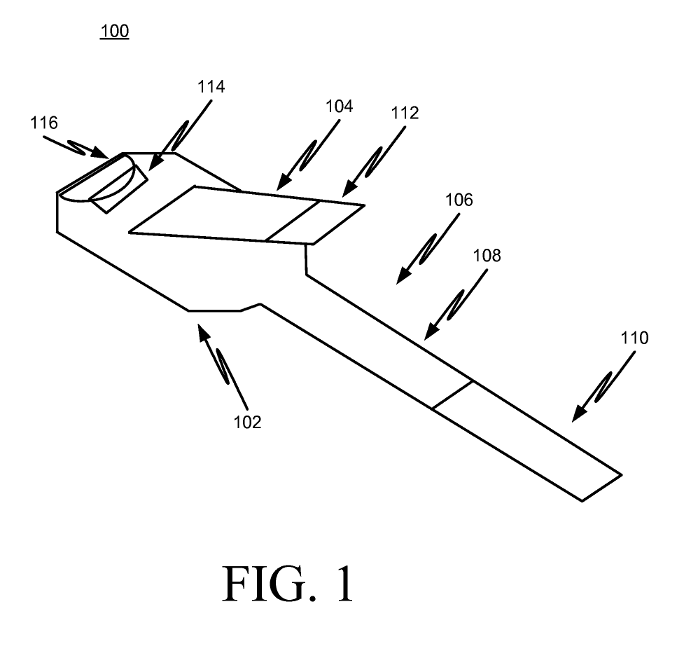

The example wrap shown in FIG. 1 includes adjustable hook and loop material 106 attached directly to a 1 mm-3 mm neoprene wrap 102. The length of the hook and loop strap can accommodate the varying size of lower legs and arms, feet, hands, and above the knee of potential users. Application includes threading the hook and loop 2″ strap through a 2″-3″ D-ring 116, for example. The D-ring is attached to the neoprene with a thick nylon woven material 114. The strap 106 is placed through the D-ring and looped back on itself. The user is able to adjust and secure the wrap firmly in place anywhere on the lower leg, arm, feet, hands, and/or above the knee. An appropriate placement can be determined by the user. Some embodiments of the wrap described herein are designed for muscular application.

Application of the different shaped soft tissue active release modulars directly onto the neoprene wrap via a hook base attached to the modular. The modular is placed under the 2″-3″ wide elastic compression straps on the anterior side of the wrap. The exact placement of the soft tissue active release modular can vary within the area of the dual woven elastic compression straps length and width. The user is then able to adjust the focal compression to their desired degree of pressure by manually hooking the elastic compression strap to the loop fabric attached to the neoprene. Using more force in attaching the compression strap results in greater degrees of pressure for the user.

The user is also able to apply directional force to the soft tissue active release modular as it is held in place with the neoprene soft tissue active release wrap. Using directional force via the users' hands, or other objects, allows the user to help pinpoint and target muscular tension with varying angles of pressure.

The user is able to isolate specific locations on the lower leg, arm, feet, hands, and/or above the knee, apply the appropriate shaped soft tissue active release modular to the small soft tissue active release extremity wrap, and engage the targeted muscle fibers/group in varying planes of movement.

For example, the device shown in FIG. 1 can include a medically therapeutic device to bind the different shaped bullets in identified soft tissue restrictions locations. The bullet can be placed directly on the skin. The hook and loop strap can be passed through the d-ring and attached to itself. The user is able to adjust the pressure and tension to their desired level. The elastic compression strap is then stretched overtop the bullet to further bind and apply focal compression to the neoprene wrap. The compression strap is applied via hook and loop and has a width of 3″. The width may change to a wider or narrower width varying up to and including 1″-2″. The compression strap is 5″ in length and may vary 1″-2″ in length. This strap is sewn on to the neoprene along a mesh nylon that attaches the plastic d-ring. The hook and loop nylon strap for attaching the wrap to the body is 17″ in length. This length has proven effective to fit appropriately on most users. The length of the strap can vary 1″-3″ in length. The width may also vary 1″-2½″ on the strap.

The small wrap extremity can be used for the lower leg of users. Some implementations can include a material 3 mm in thickness. Some implementations can be 8″ in length and 5″ in width. The adjustability and attached compression strap allows the user to intensify the focal compression to the desired level. The user is then instructed to activate the appropriate musculature in various movement patterns as the present device is attached. The movement patterns target the muscles adhesion, restriction, tightness which the bullet is contacting. Some implementations can be resourced for periods of time recommended by medical professionals.

An embodiment can be configured to be applied to the anterior side of the forearm, for example. The adjustable strap can be secured at a desired level of pressure. The compression strap can be secured via hook and loop to the desired level of compression. The tear drop bullet can be attached to the embodiment via hook and loop. The location of the bullet can be placed over an adhesion. The user activates the extensor and flexor muscles of the forearm. As the muscles are activated under the focal compression of the system, the bullet is held securely in place. This creates a gliding, massage stroke, penetrating deep muscle fibers and restrictions. The user can create a large number of movement options that seek to highlight and elicit a pain response. This pain response decreases in intensity as the user continues application of the system. The research has been conducted by the inventor on over 100 different athletes and clients. Results varied but a high percentage showed decreases in pain and inflammation, and increases in range of motion to applied soft tissue structures.

Some embodiments can include a soft tissue active release wrap configured for use, for example, in a flexion of wrist with slight medial rotation. This type of use can help to differentiate muscle fibers located on the forearm. The user is able to adjust pressure, focal compression, location, angle of penetration, all fitting the soft tissue active release wrap to meet individual needs.

Some implementations can include a medically therapeutic device to bind the different shaped bullets on identified soft tissue restrictions in accordance with at least one embodiment. The bullet is placed directly on the skin. The hook and loop strap is passed through the d-ring and attached to itself. The user is able to adjust the pressure and tension to their desired level. The elastic compression strap is then stretched overtop the bullet to further bind and apply focal compression to the neoprene wrap. The compression strap is applied via hook and loop and has a width of 3″. The width may change to a wider or narrower width varying up to and including 1″-2″ in increase or decrease in width. The compression strap is 8″ in length and may vary ½″-4″ increase or decrease in length. The strap is sewn on to the neoprene along a mesh nylon that attaches the plastic d-ring. The hook and loop nylon strap for attaching the wrap to the body is 14″ but may vary between ½″ to 4″ increase or decrease in length. The soft tissue active release upper leg wrap neoprene/or similar material including hemp or other natural fibers is 17″ in length but may vary from about ½″ to 5″ increase or decrease in length. The width of the neoprene/other natural material is 5″ but may vary ¼″ to 3″ increase or decrease in width. The thickness of the soft tissue active release upper leg wrap can be about 3 mm but may vary from about ½ mm to 2 mm in thickness. The ease of use and adjustability help makes the soft tissue active release wrap suitable for many soft tissue restrictions and locations. As well, the user is able to apply the soft tissue active release wrap without using force or pressure applied with the user's own hands. This provides a user the ability to move and be active while wearing the device while receiving the benefits of use.

Some embodiments can include a soft tissue active release wrap configured for use on an upper leg of a user held in place on the hamstring muscles while user flexes at the knee. The use of a firm surface can add additional compression for the soft tissue active release upper leg wrap configured for use on the hamstring muscles.

Some implementations can be used on the lower leg (e.g., in lateral flexion while wearing the soft tissue active release upper leg wrap). This movement can help isolate and differentiate muscle fibers that are held under focal compression. Additional compression is created by the user placing upper leg on a firm surface and moving the leg in various directions.

With some embodiments, a user can move the lower leg in medial flexion while wearing the soft tissue active release upper leg wrap. This movement helps isolate and differentiate muscle fibers that are held under focal compression. Additional compression is created by the user placing upper leg on a firm surface and moving the leg in various directions.

Some implementations can include a shoulder wrap configured to connect around the arm, and having a 1 mm-3 mm neoprene wrap that wraps around the pectorals anteriorly and along the rotator cuff and rhomboids posteriorly and then attaches around the chest area underneath the opposite arm.

Some implementations can include a medically therapeutic device to bind the different shaped bullets on identified soft tissue restrictions in accordance with at least one embodiment. The bullet is placed directly on the skin. The hook and loop strap is passed through the d-ring and attached to itself. The user is able to adjust the pressure and tension to their desired level. The elastic compression strap is then stretched overtop the bullet to further bind and apply focal compression to the neoprene wrap. The compression strap is applied via hook and loop and has a width of 3″. The width may change to a wider or narrower width varying up to and including 1″-2″ in increase or decrease in width. The compression strap is 8″ in length and may vary ½″-4″ increase or decrease in length. The strap is sewn on to the neoprene along a mesh nylon that attaches the plastic d-ring. The hook and loop nylon strap for attaching the wrap to the body is 29″ but may vary between ½″ to 4″ increase or decrease in length. The soft tissue active release upper body and hips wrap neoprene/or similar material including hemp or other natural fibers is 27″ in length but may vary from ½″ to 5″ increase or decrease in length. The width of the neoprene/other natural material is 5″ but may vary ¼″ to 3″ increase or decrease in width. The thickness of the soft tissue active release upper body and hips wrap is 3 mm but may vary from ½ mm to 2 mm in thickness. The ease of use and adjustability help make the soft tissue active release wrap ideal for many soft tissue restrictions and locations. As well, the user is able to apply the soft tissue active release wrap without using force or pressure applied with the user's own hands. This provides a user the ability to move and be active while wearing the device while receiving the benefits of use.

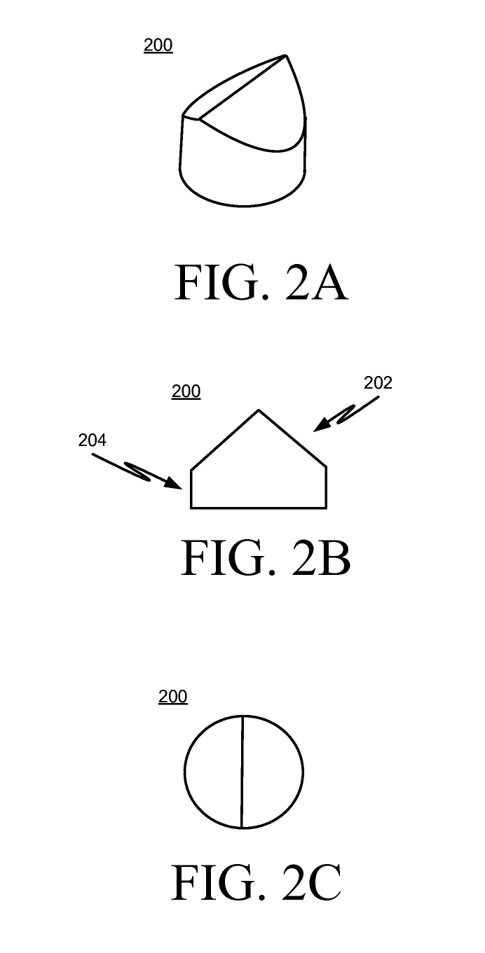

FIGS. 2A-2C show a soft tissue active release wedge shaped module having a linear contact portion 202 extending from a base portion 204, the wedge shaped module can be made of a polymer with density of shore A, hardness 61, but may vary in hardness within 1 degree to 20 degrees. The exact composition of the material may also vary as volume increases. The material is FDA approved for contact with the skin, and is likely to remain approved for skin contact. The shape of the soft tissue active release module shown in FIGS. 2A-2C was researched and designed to create an effective point of contact with precision and hold a 2″ linear line of contact. The exact line shown in the embodiment of FIGS. 2A-2C is 1 mm wide, but can vary in width from ½ mm to 3 mm. This design was created to address the width of most muscles and apply focal compression directly to the skin. This unique shape of object differs from most self-use massage tools on the market today that lack specificity where they make contact with the body. This design was created because soft tissue restrictions are extremely specific locations in the body. Also called trigger points, these adhesions require appropriate stimulation in order to challenge the fibers, and create a change in the tissue. The wedge-shaped module is adapted for users who have tight muscles with adhesions, scar tissue, inflammation, strains, or sprains. The wedge shape effectively isolates muscle fibers in a 2″ length, but we may vary the length by ¼″ to 3″ increases or decrease in length. The height of the soft tissue active release wedge-shaped module in FIG. 2A is 1.25″. This height may vary from ⅛″ to 2″ increase or decrease in height. The height was designed to penetrate into soft tissue structures with enough depth to address deeper, restrictions and adhesions. The height of the example shown in FIG. 2A needed to be enough to effectively treat these adhesions. The objective was to offer an appropriate stimulus to the muscles of the body where adaptation would occur to the stimulus, but not create too much of a stimulus where irritation, and/or damage to the tissue would ensue. A recommended usage can include 5-10 minutes of use for each application on the body of the user.

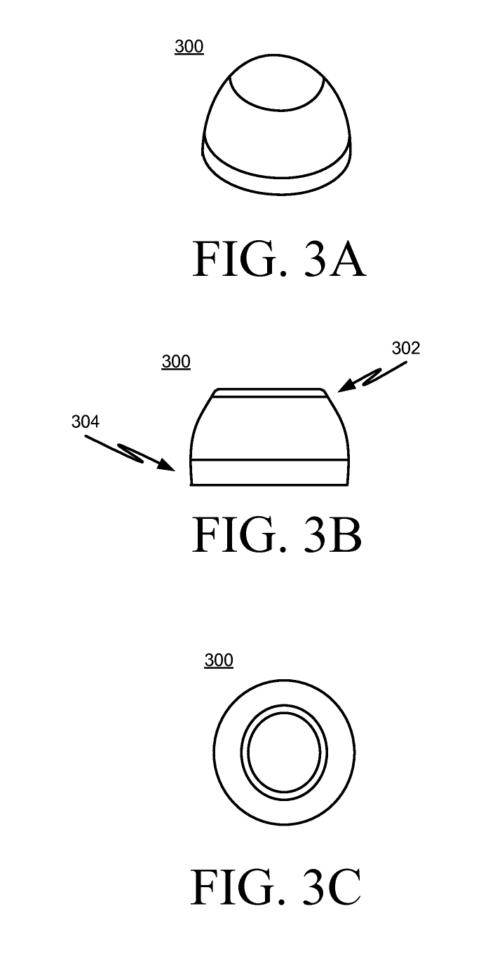

As shown in FIGS. 3A-3C, an example soft tissue active release Bullet Diffuser is made of a polymer with density of shore A, hardness 61, but may vary in hardness within 1 degree to 20 degrees. The exact composition of the material may also vary as volume increase. The material is FDA approved for contact with the skin, and will remain approved for skin contact. The shape of the soft tissue active release Bullet Enforcer was researched and designed to create an effective point of contact with precision and hold a 1″ point of contact. This design was created to address a more general focal compression directly to the skin. This unique shape offers user who can't isolate or point to their specific soft tissue restrictions an application that begins the process of identifying the muscle fibers that are responsible for pain and tightness in the muscles. The shape effectively isolates muscle fibers in a 1″ circumference, but we may vary the length by ¼″ to 3″ increases or decrease in circumference. The height of the soft tissue active release Bullet Diffuser in FIG. 3A is 1.25″. This height may vary from ⅛″ to 2″ increase or decrease in height. The height was designed to penetrate into soft tissue structures with enough depth to address deeper, restrictions and adhesions. The height of the example shown in FIG. 3A needed to be enough to effectively treat these adhesions. The objective was to offer an appropriate stimulus to the muscles of the body where adaptation would occur to the stimulus, but not create too much of a stimulus where irritation and/or damage to the tissue would ensue. A recommended usage can include 5-10 minutes of use for each application on the body of the user.

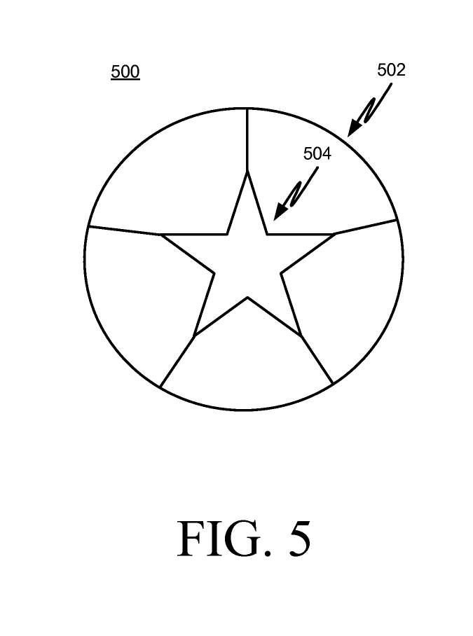

FIG. 5 shows an example pressure module having a generally star-shaped member in accordance with at least one embodiment. For example, the star-shaped member can be about ¼ inch with a height of about 2 inches.

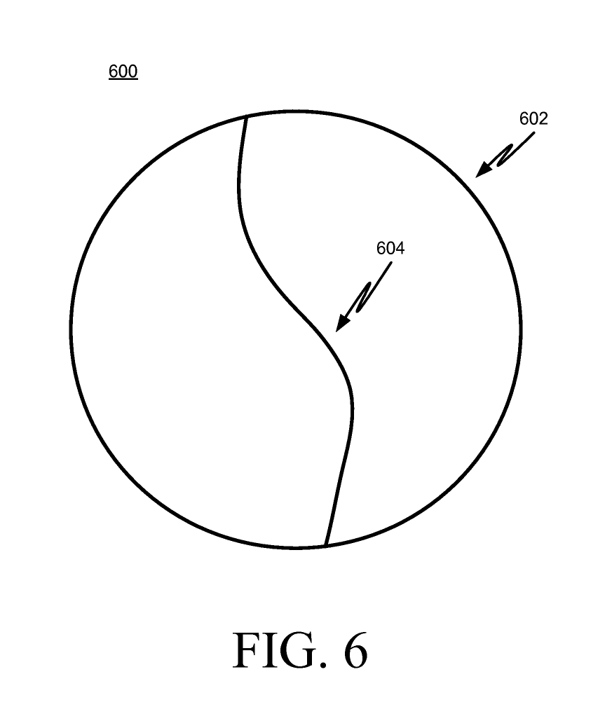

FIG. 6 shows an example pressure module having a generally “S”-shaped member about two inches high in the central portion and sloping toward the outer perimeter of the module.

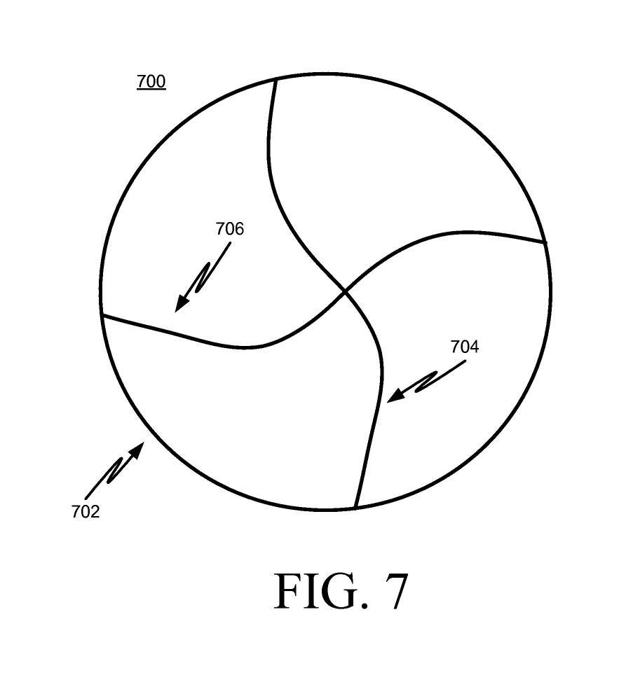

FIG. 7 shows an example pressure module having two intersecting generally “S”-shaped members about two inches high in the central portion and sloping toward the outer perimeter of the module.

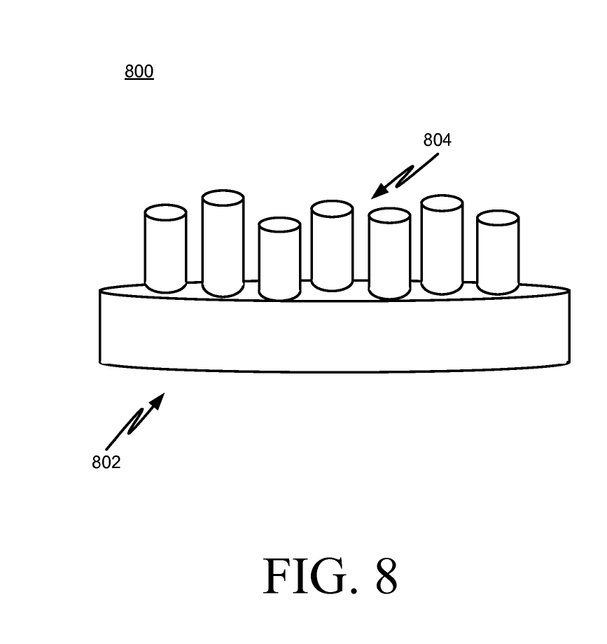

FIG. 8 shows an example pressure module having a plurality of generally cylindrical members. Each cylindrical member can have a rounded distal end. Also, the entire module can be convex.

It is, therefore, apparent that there is provided, in accordance with the various embodiments disclosed herein, soft tissue active release systems.

While the disclosed subject matter has been described in conjunction with a number of implementations, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A system for soft tissue active release, the system comprising:
a wrap portion;
a strap coupled to the wrap portion, the strap having a fastening system attached thereto;
an attachment point coupled to the wrap portion; and
one or more pressure modules.

2. The system of claim 1, wherein the wrap portion is configured to be placed around one of an arm, hand or foot.

3. The system of claim 1, wherein the wrap portion is configured to be placed around a leg.

4. The system of claim 1, wherein the wrap portion is configured to be placed around a torso.

5. The system of claim 1, wherein one of the one or more pressure modules includes a generally wedge shaped member.

6. The system of claim 1, wherein one of the one or more pressure modules includes a generally recessed circular shaped member.

7. The system of claim 1, wherein one of the one or more pressure modules includes a generally pointed member.

8. The system of claim 1, wherein one of the one or more pressure modules includes a generally star shaped member.

9. The system of claim 1, wherein one of the one or more pressure modules includes a raised generally s-shaped member.

10. The system of claim 1, wherein one of the one or more pressure modules includes a member having two raised generally s-shaped portions that intersect.

11. The system of claim 1, wherein one of the one or more pressure modules includes a module having a plurality of raised portions each having a generally cylindrical shape.
